(19) United States
(12) Patent Application Publication
(10) Pub. No.: US 2019/0342489 A1
(43) Pub. Date: Nov. 7, 2019

(54) ELECTRONIC DEVICE, CONTROL DEVICE, AND CONTROL METHOD

(71) Applicant: SHARP KABUSHIKI KAISHA, Osaka (JP)

(72) Inventors: KOICHI YAMAGUCHI, Sakai City (JP); YUSUKE OKUDA, Sakai City (JP); KENICHI OKAMOTO, Sakai City (JP)

(21) Appl. No.: 16/396,293

(22) Filed: Apr. 26, 2019

(30) Foreign Application Priority Data
May 7, 2018 (JP) 2018-089316

(51) Int. Cl. H04N 5/232; G06F 1/16; H04N 5/235

(52) U.S. Cl. CPC H04N 5/23216; H04N 5/2353; G06F 1/1686

(57) ABSTRACT

The present invention makes it possible that, in a case where, while image capturing is carried out with use of one of two different image capturing devices, image capturing is carried out with use of the other, appearances of a moving image and a still image captured by the respective two different image capturing devices match each other. In a case where image capturing for capturing a still image of a subject is carried out with use of a second camera while image capturing for capturing a moving image of the subject is carried out with use of a first camera, the image capturing of the still image is carried out on the basis of a moving image capture parameter.

This Nonprovisional application claims priority under 35 U.S.C. § 119 on Patent Application No. 2018-089316 filed in Japan on May 7, 2018, the entire contents of which are hereby incorporated by reference.

### TECHNICAL FIELD

The present invention relates to an electronic device, a control device, and a control method.

### BACKGROUND ART

A technology for improving an appearance of an image captured by an image capturing device has been disclosed. For example, Patent Literature 1 discloses a technology of performing image correction on second captured image data serving as a background region and third captured image serving as a main subject region, both of which have been generated from first captured image data.

### CITATION LIST

### Patent Literature

[Patent Literature 1]

Japanese Patent Application Publication, Tokukai, No. 2016-149631 A (Publication Date: Aug. 18, 2016)

### SUMMARY OF INVENTION

### Technical Problem

However, according to the conventional technology as described above, in a case where, while image capturing is carried out with use of one of two different image capturing devices, image capturing is carried out with use of the other, it may not necessarily be possible to cause an appearance (brightness, coloration, etc.) of a moving image captured by one of the two different image capturing devices to match an appearance of a still image captured by the other.

It is an object of an aspect of the present invention to make it possible that, in a case where, while image capturing is carried out with use of one of two different image capturing devices, image capturing is carried out with use of the other, appearances of a moving image and a still image captured by the respective two different image capturing devices match each other.

### Solution to Problem

In order to attain the object, an electronic device in accordance with an aspect of the present invention is an electronic device including: at least one first image capturing device configured to capture a moving image; at least one second image capturing device configured to capture a still image; and at least one control device, wherein in a case where the at least one control device carries out, while carrying out image capturing for capturing an image of a subject with use of one of the at least one first image capturing device and the at least one second image capturing device, image capturing for capturing an image of the subject with use of the other, the at least one control device carries out, on the basis of an image capture parameter indicative of an imaging capturing condition in the image capturing with use of the one of the at least one first image capturing device and the at least one second image capturing device, a process of the image capturing for capturing the image of the subject with use of the other.

Further, in order to attain the object, a control device in accordance with an aspect of the present invention is a control device for controlling an electronic device, the control device configured to: carry out, when carrying out image capturing for capturing an image of a subject with use of one of (i) at least one first image capturing device configured to capture a moving image and (ii) at least one second image capturing device configured to capture a still image, a process of the image capturing on the basis of an image capture parameter indicative of an imaging capturing condition in image capturing carried out with use of the other.

Further, in order to attain the object, a control method in accordance with an aspect of the present invention is a control method control method for controlling an electronic device, the control method including: carrying out, when carrying out image capturing for capturing an image of a subject with use of one of (i) at least one first image capturing device configured to capture a moving image and (ii) at least one second image capturing device configured to capture a still image, a process of the image capturing on the basis of an image capture parameter indicative of an imaging capturing condition in image capturing carried out with use of the other.

### Advantageous Effects of Invention

According to an aspect of the present invention, it becomes possible that, in a case where image capturing with use of one of two different image capturing devices is performed while image capturing with use of the other is performed, appearances of a moving image and a still image captured by the respective two different image capturing devices match each other.

### BRIEF DESCRIPTION OF DRAWINGS

FIG. 1 is a functional block diagram illustrating a configuration of a main part of an electronic device in accordance with Embodiment 1.

FIG. 2 is a flowchart illustrating a flow of a process carried out by the electronic device in accordance with Embodiment 1.

FIG. 3 is an example of a table that an image capture control section refers to when converting a moving image capture parameter to a still image capture parameter in Embodiment 1.

### DESCRIPTION OF EMBODIMENTS

### Embodiment 1

The following description will discuss an electronic device 1 in accordance with Embodiment 1.

(Summary of Electronic Device 1)

The electronic device 1 is an electronic device that has a camera function of capturing a still image and a moving image. The electronic device 1 can capture a still image while capturing a moving image and can capture a moving image while capturing a still image. Examples of the electronic device 1 include a smartphone and a digital camera.

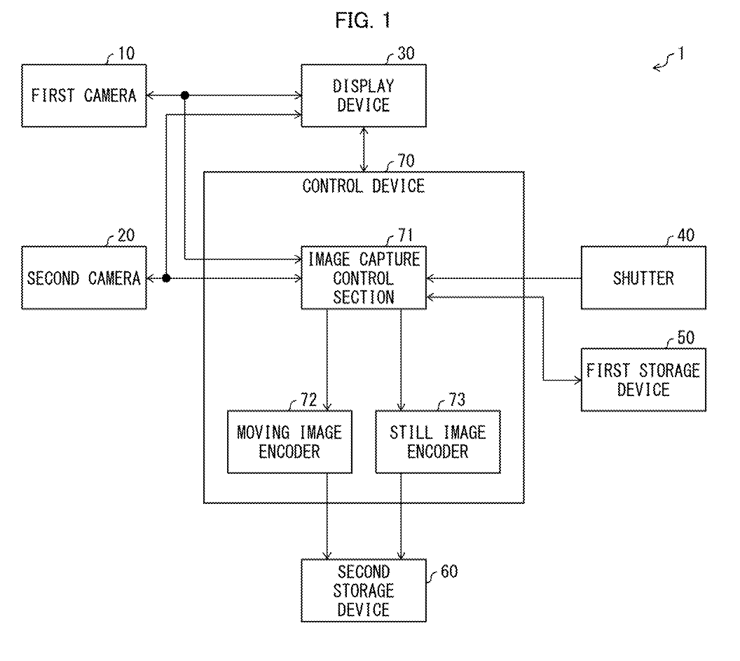

FIG. 1 is a functional block diagram illustrating a configuration of a main part of the electronic device 1. The electronic device 1 includes a first camera 10 (first image capturing device), a second camera 20 (second image capturing device), a display device 30, a shutter 40, a first storage device 50, a second storage device 60, and a control device 70.

The first camera 10 is a camera module configured to capture a moving image. The first camera 10 captures a moving image with use of a moving image capture parameter (image capture parameter), which is associated with the first camera 10 and indicates a condition under which a moving image is captured. The second camera 20 is a camera module configured to capture a still image. The second camera 20 captures a still image with use of a still image capture parameter (image capture parameter), which is associated with the second camera 20 and indicates a condition under which a still image is captured.

The moving image capture parameter associated with the first camera 10 and the still image capture parameter associated with the second camera 20 each include, for example, an automatic exposure adjustment parameter (AE), an automatic white balance adjustment parameter (AWB), an autofocus parameter (AF), and a zooming magnification, but the present invention is not limited to this.

The display device 30 is a display device configured to display a moving image and a still image captured by the first camera 10 and the second camera 20, respectively. The display device 30 may be provided integrally with a touch sensor that is configured to display an object for receiving an operation carried out by a user and receive the user's operation of the object. Examples of the display device 30 include a liquid crystal panel and an organic EL (electroluminescence) display.

The shutter 40 is a user interface configured to receive an operation indicating that image capturing by at least one of the first camera 10 and the second camera 20 is to be started. Examples of the shutter 40 include a button and a switch, such as a key, which are displayed on the display device 30. Further, the shutter 40 may be configured to receive an operation using audio and, when a predetermined speech is inputted, receive the predetermined speech as an operation indicating that image capturing is to be started. Further, the shutter 40 may be configured such that the electronic device 1 determines timing for clicking the shutter through image recognition or the like and the shutter 40 automatically starts image capturing.

The first storage device 50 is a storage device in which the moving image capture parameter associated with the first camera 10 is stored. The second storage device 60 is a storage device in which a moving image captured by the first camera 10 and a still image captured by the second camera 20 are stored. Examples of the first storage device 50 and the second storage device 60 include a RAM (random access memory), a flash memory, an SD card, and a hard disk drive.

The control device 70 is a control device which centrally controls individual sections of the electronic device 1. Examples of the control device 70 include a CPU (central processing unit). The control device 70 may include a control device (e.g., a DSP (digital signal processor)) of another chip.

Note that FIG. 1 illustrates an example case in which the number of each type of section included in the electronic device 1 is one (1), but the present invention is not limited to such a case. That is, it is only necessary that the number of sections of the same type included in the electronic device 1 is at least one.

(Details of Control Device 70)

The control device 70 also functions as an image capture control section 71, a moving image encoder 72, and a still image encoder 73.

The image capture control section 71 acquires information from the sections connected to the image capture control section 71 (the first camera 10, the second camera 20, the shutter 40, and the first storage device 50), and controls the sections with reference to the information acquired.

The moving image encoder 72 encodes a moving image captured by the first camera 10. The moving image encoder 72 stores the moving image encoded in the second storage device 60.

The still image encoder 73 encodes a still image captured by the second camera 20. The still image encoder 73 stores the still image encoded in the second storage device 60.

(Process Carried Out by Control Device 70)

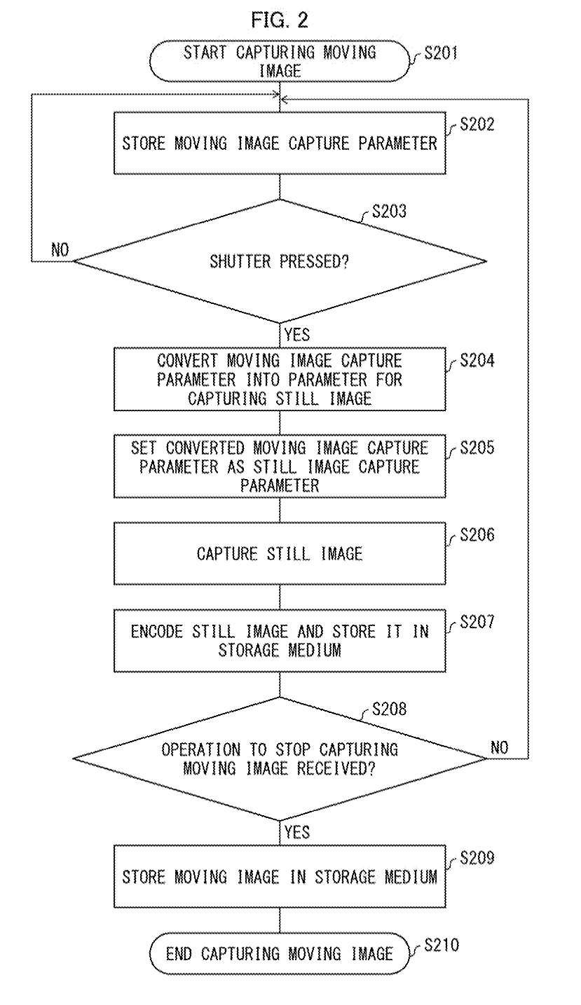

FIG. 2 is a flowchart illustrating a flow of a process carried out by the electronic device 1 in accordance with Embodiment 1 (a control method for controlling the electronic device 1).

When the shutter 40 receives an operation indicating that a moving image is to be captured, the shutter 40 outputs, to the image capture control section 71, operation information indicating that the operation has been received. Upon acquiring the operation information, the image capture control section 71 starts capturing a moving image of a subject with use of the first camera 10 (S201). Note that the operation information may be acquired from the display device 30 that includes a touch sensor.

The image capture control section 71 refers to the subject in the moving image captured by the first camera 10, and updates the moving image capture parameter associated with the first camera 10 at predetermined intervals (e.g., every 50 msec). The image capture control section 71 stores thus updated moving image capture parameter associated with the first camera 10 in the first storage device 50 at the predetermined intervals (S202). Next, the image capture control section 71 determines whether or not the shutter has been pressed (S203). Specifically, the image capture control section 71 determines whether or not operation information, which indicates that an operation indicating that “a still image is to be captured” has been received, has been acquired from the shutter 40 (or the display device 30). In a case where the image capture control section 71 determines that the shutter has not been pressed, the image capture control section 71 returns to the process of S202.

On the other hand, in a case where the image capture control section 71 determines that the shutter has been pressed, the image capture control section 71 converts the moving image capture parameter, which is stored in the first storage device 50 and indicates the condition under which the first camera 10 is currently performing image capturing, into a parameter for capturing a still image (for the second image capturing device) (S204). That is, the image capture control section 71 converts a moving image capture parameter, which is used in moving image capturing carried out with use of the first camera 10, into a still image capture parameter for the second camera 20. Then, the image capture control section 71 sets the moving image capture parameter thus converted as a still image capture parameter (S205).

Examples of a method by which the image capture control section 71 converts a moving image capture parameter into a still image capture parameter include a conversion method using a table and a conversion method using a function. In a case of using the conversion method using a table, the image capture control section 71 derives a still image capture parameter by referring to a table in which a moving image capture parameter and a still image capture parameter that has been converted are associated with each other. In a case of using the conversion method using a function, the image capture control section 71 derives a still image capture parameter by inputting a moving image capture parameter to the function.

Further, the image capture control section 71 may be configured to select either the conversion method using a table or the conversion method using a function, depending on possible values of each of a moving image capture parameter and a still image capture parameter. For example, the image capture control section 71 may be configured to: use the conversion method using a table in a case where the number of possible values for each of a still image capture parameter and a moving image capture parameter is limited (e.g., the possible values are in 10 stages); and use the conversion method using a function in a case where the numerical value continuously changes and the number of possible values for each of a still image capture parameter and a moving image capture parameter is large (e.g., the possible values are in 10,000 stages).

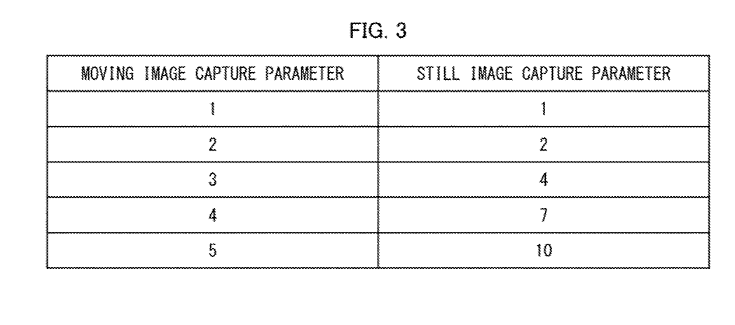

FIG. 3 is an example of a table that the image capture control section 71 refers to when converting a moving image capture parameter (e.g., an automatic exposure adjustment parameter) to a still image capture parameter. In the table of FIG. 3, the moving image capture parameter may take the values in five stages of “1” to “5” and the still image capture parameter may take the values in 10 stages of “1” to “10”. The image capture control section 71 sets the still image capture parameter associated with the second camera 20, for example, to “1” in a case where the moving image capture parameter is “1” and to “7” in a case where the moving image capture parameter is “4”.

The function used by the image capture control section 71 when carrying out conversion by the conversion method using a function may be, for example, the following equation (1):

y=ax+b (1)

wherein x is a moving image capture parameter (in this case, an automatic exposure adjustment parameter); y is a still image capture parameter corresponding to x; and a and b are constants pre-adjusted based on characteristics of the first camera 10 and the second camera 20.

The image capture control section 71 sets y, which has been calculated by inputting a value of the moving image capture parameter to x in Equation (1), to the still image capture parameter.

Next, the image capture control section 71 performs a process of capturing a still image of the subject with use of the second camera 20 and the still image capture parameter associated with the second camera 20 (S206). When the image capture control section 71 acquires the still image captured by the second camera 20, the image capture control section 71 outputs the still image to the still image encoder 73. The still image encoder 73 acquires and encodes the still image outputted, and stores the still image encoded in the second storage device 60 (S207).

Then, the image capture control section 71 determines whether or not an operation indicating that “capturing of the moving image is to be stopped” has been received. Specifically, the image capture control section 71 determines whether or not operation information, which indicates that an operation indicating that “capturing of the moving image is to be stopped” has been received, has been acquired from the shutter 40 (or the display device 30). In a case where the image capture control section 71 determines that the operation indicating that “capturing of the moving image is to be stopped” has not been received, the image capture control section 71 returns to the process of S202.

On the other hand, in a case where the image capture control section 71 determines that the operation indicating that “capturing of the moving image is to be stopped” has been received, the image capture control section 71 acquires the moving image captured by the first camera 10 and outputs the moving image to the moving image encoder 72. The moving image encoder 72 acquires and encodes the moving image outputted, and stores the moving image encoded in the second storage device 60 (S209). The control device 70 then ends capturing of the moving image (S210).

As described above, in a case where the electronic device 1 carries out, while carrying out image capturing for capturing a moving image of a subject with use of the first camera (one), image capturing for capturing a still image of the subject with use of the second camera 20 (the other), the electronic device 1 carries out, on the basis of a moving image capture parameter indicative of an image capturing condition associated with the first camera 10, the image capturing for capturing the still image of the subject. Accordingly, the electronic device 1 can cause appearances of a moving image and a still image captured by the respective two different cameras, i.e., the first camera 10 and the second camera 20, to match each other.

Further, the electronic device 1 converts a moving image capture parameter associated with the first camera 10 into a still image capture parameter associated with the second camera 20, and captures a still image using the still image capture parameter. Generally, lenses differing in characteristic (e.g., F value) are used for the first camera 10 for imaging a moving image and the second camera 20 for imaging a still image. Even in such a case, since the electronic device 1 converts a moving image capture parameter into a still image capture parameter when capturing a still image, it is possible to cause appearances of a moving image and a still image captured by the respective two cameras differing in characteristic, i.e., the first camera 10 and the second camera 20, to match each other.

Further, the electronic device 1 performs image capturing with use of a moving image capture parameter and a still image capture parameter each including at least one of an automatic exposure adjustment parameter and a white balance adjustment parameter. This allows the electronic device 1 to match brightness and coloration between a moving image and a still image captured by the first camera 10 and the second camera 20, respectively.

Further, the electronic device 1 carries out image capturing with use of a moving image capture parameter and a still image capture parameter each including zooming magnification. Accordingly, the electronic device 1 can cause sizes of a moving image and a still image captured by the respective two different cameras, i.e., the first camera 10 and the second camera 20, to match each other.

In Embodiment 1, the above description has discussed a case in which the electronic device 1 captures a still image using the second camera 20 while capturing a moving image using the first camera 10, but the present invention is not limited to this case. That is, also in a case where the electronic device 1 carries out, while carrying out image capturing for capturing a still image with use of the second camera 20 (one), image capturing for capturing a moving image with use of the first camera 10 (the other), the electronic device 1 carries out, on the basis of a still image capture parameter indicative of an image capturing condition in the image capturing for capturing the still image with use of the second camera, a process of the image capturing for capturing the moving image with use of the first camera 10. Accordingly, even in a case where the electronic device 1 carries out image capturing for capturing a moving image with use of the first camera 10 while carrying out image capturing for capturing a still image with use of the second camera 20, the electronic device 1 can cause appearances of the moving image and the still image captured by the respective different cameras, i.e., the first camera 10 and the second camera 20, to match each other.

In Embodiment 1, the above description has discussed a configuration in which the electronic device 1 converts a moving image capture parameter to derive a still image capture parameter, but the present invention is not limited thereto. That is, the electronic device 1 may be configured to make direct use of a moving image capture parameter as a still image capture parameter.

The electronic device 1 may be configured to select a parameter to be converted according to circumstances. For example, in a case where three parameters are included in a moving image capture parameter, the electronic device 1 may be able to select one of: converting one of the three parameters; converting two of the three parameters; and converting the three parameters, according to circumstances.

[Software Implementation Example]

The control device 70 of the electronic device 1 can be realized by a logic circuit (hardware) provided in an integrated circuit (IC chip) or the like or can be alternatively realized by software.

In the latter case, the electronic device 1 includes a computer that executes instructions of a program that is software realizing the foregoing functions. The computer, for example, includes at least one processor (control device) and at least one computer-readable storage medium storing the program. The object of the present invention can be achieved by the processor of the computer reading and executing the program stored in the storage medium. The processor may be, for example, a CPU (Central Processing Unit). The storage medium may be “a non-transitory tangible medium” such as a ROM (Read Only Memory), a tape, a disk, a card, a semiconductor memory, and a programmable logic circuit. The computer may further include a RAM (Random Access Memory) or the like in which the program is loaded. Further, the program may be supplied to or made available to the computer via any transmission medium (such as a communication network and a broadcast wave) which enables transmission of the program. Note that one aspect of the present invention can also be implemented by the program in the form of a computer data signal embedded in a carrier wave which is embodied by electronic transmission.

[Recap]

An electronic device (1) in accordance with Aspect 1 of the present invention is an electronic device including: at least one first image capturing device (first camera 10) configured to capture a moving image; at least one second image capturing device (second camera 20) configured to capture a still image; and at least one control device (70), wherein in a case where the at least one control device carries out, while carrying out image capturing for capturing an image of a subject with use of one of the at least one first image capturing device and the at least one second image capturing device, image capturing for capturing an image of the subject with use of the other, the at least one control device carries out, on the basis of an image capture parameter indicative of an imaging capturing condition in the image capturing with use of the one of the at least one first image capturing device and the at least one second image capturing device, a process of the image capturing for capturing the image of the subject with use of the other.

According to the above configuration, in a case where the electronic device carries out, while carrying out image capturing for capturing a moving image with use of the at least one first image capturing device, image capturing for capturing a still image with use of the at least one second image capturing device (or in a case where the electronic device carries out, while carrying out image capturing for capturing a still image with use of the at least one second image capturing device, image capturing for capturing a moving image with use of the at least one first image capturing device), the electronic device can cause an appearance of the moving image being captured and an appearance of the still image (or an appearance of the still image being captured and an appearance of the moving image) to match each other. Thus, in a case where the electronic device carries out, while carrying out image capturing with use of one of two different image capturing devices (i.e., the at least one first image capturing device and the at least one second image capturing device), image capturing with use of the other, the electronic device can cause appearances of the moving image and the still image respectively captured by the at last one first image capturing device and the at least one second image capturing device to match each other.

In Aspect 2 of the present application, the electronic device in accordance with Aspect 1 may be configured such that in a case where the at least one control device carries out, while carrying out image capturing for capturing an image of the subject with use of the at least one first image capturing device, image capturing for capturing an image of the subject with use of the at least one second image capturing device, the at least one control device carries out, on the basis of an image capture parameter in the image capturing with use of the at least one first image capturing device, the image capturing with use of the at least one second image capturing device.

According to the above configuration, in a case where the electronic device carries out, while carrying out image capturing for capturing a moving image with use of the at least one first image capturing device, image capturing for capturing a still image with use of the at least one second image capturing device, the electronic device can cause an appearance of the moving image being captured and an appearance of the still image to match each other. Thus, in a case where the electronic device carries out, while carrying out image capturing for capturing a moving image with use of the at least one first image capturing device, image capturing for capturing a still image with use of the at least one second image capturing device, the electronic device can cause appearances of the moving image and the still image captured by the respective two different image capturing devices (i.e., the at last one first image capturing device and the at least one second image capturing device) to match each other.

In Aspect 3 of the present application, the electronic device in accordance with Aspect 2 may be configured such that the at least one control device converts an image capture parameter associated with the at least one first image capturing device into an image capture parameter for the at least one second image capturing device and captures a still image with use of the image capture parameter that has been converted.

According to the above configuration, the electronic device converts an image capture parameter in image capturing carried out with use of the at least one first image capturing device into an image capture parameter for the second image capturing device, and captures a still image. Thus, even in a case where the at least one first image capturing device and the at least one second image capturing device differ in characteristic (e.g., F value of a lens), the electronic device can cause appearances of a moving image and a still image respectively captured by the at least one first image capturing device and the at least one second image capturing device to match each other.

In Aspect 4 of the present application, the electronic device in accordance with Aspect 2 may be configured such that the at least one control device carries out, with direct use of an image capture parameter associated with the at least one first image capturing device, the image capturing with use of the at least one second image capturing device.

In Aspect 5 of the present application, the electronic device in accordance with any one of Aspects 1 to 4 may be configured such that the image capture parameter includes at least one of an automatic exposure adjustment parameter and a white balance adjustment parameter.

According to the above configuration, the electronic device carries out, with use of at least one of an automatic exposure adjustment parameter and a white balance adjustment parameter in image capturing carried out with use of one of the at least one first image capturing device and the at least one second image capturing device, a process of image capturing with use of the other. Thus, in a case where the electronic device carries out, while carrying out image capturing with use of one of two different image capturing devices (i.e., the at least one first image capturing device and the at least one second image capturing device), image capturing with use of the other, the electronic device can cause brightness and/or coloration of a moving image captured by the at last one first image capturing device to match brightness and/or coloration of a still image captured by the at least one second image capturing device.

In Aspect 6 of the present application, the electronic device in accordance with Aspect 5 may be configured such that the image capture parameter further includes zooming magnification.

According to the above configuration, the electronic device carries out, with use of a zooming magnification in image capturing carried out with use of one of the at least one first image capturing device and the at least one second image capturing device, a process of image capturing with use of the other. Thus, in a case where the electronic device carries out, while carrying out image capturing with use of one of two different image capturing devices (i.e., the at least one first image capturing device and the at least one second image capturing device), image capturing with use of the other, the electronic device can cause a size of the subject included in a moving image captured by the at last one first image capturing device to match a size of the subject included in a still image captured by the at least one second image capturing device.

A control device in accordance with Aspect 7 of the present invention is a control device for controlling an electronic device, the control device configured to: carry out, when carrying out image capturing for capturing an image of a subject with use of one of (i) at least one first image capturing device configured to capture a moving image and (ii) at least one second image capturing device configured to capture a still image, a process of the image capturing on the basis of an image capture parameter indicative of an imaging capturing condition in image capturing carried out with use of the other.

According to the above configuration, it is possible to realize a control device having the same effects as those of the electronic device in accordance with Aspect 1.

A control method in accordance with Aspect 8 of the present invention is a control method for controlling an electronic device, the control method including: carrying out, when carrying out image capturing for capturing an image of a subject with use of one of (i) at least one first image capturing device configured to capture a moving image and (ii) at least one second image capturing device configured to capture a still image, a process of the image capturing on the basis of an image capture parameter indicative of an imaging capturing condition in image capturing carried out with use of the other.

According to the above configuration, it is possible to realize a control method having the same effects as those of the electronic device in accordance with Aspect 1.

The electronic device according to the foregoing embodiments of the present invention may be realized by a computer. In this case, the present invention encompasses: a control program for the electronic device which program causes a computer to operate as the foregoing sections (software elements) of the electronic device so that the electronic device can be realized by the computer; and a computer-readable storage medium storing the control program therein.

[Supplementary Note]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Electronic device
10: First camera (first image capturing device)
20: Second camera (second image capturing device)
30: Display device
40: Shutter
50: First storage device
60: Second storage device
70: Control device
71: Image capture control section
72: Moving image encoder
73: Still image encoder

1. An electronic device comprising:
at least one first image capturing device configured to capture a moving image;
at least one second image capturing device configured to capture a still image; and
at least one control device, wherein
in a case where the at least one control device carries out, while carrying out image capturing for capturing an image of a subject with use of one of the at least one first image capturing device and the at least one second image capturing device, image capturing for capturing an image of the subject with use of the other, the at least one control device carries out, on the basis of an image capture parameter indicative of an imaging capturing condition in the image capturing with use of the one of the at least one first image capturing device and the at least one second image capturing device, a process of the image capturing for capturing the image of the subject with use of the other.

2. The electronic device as set forth in claim 1, wherein
in a case where the at least one control device carries out, while carrying out image capturing for capturing an image of the subject with use of the at least one first image capturing device, image capturing for capturing an image of the subject with use of the at least one second image capturing device, the at least one control device carries out, on the basis of an image capture parameter in the image capturing with use of the at least one first image capturing device, the image capturing with use of the at least one second image capturing device.

3. The electronic device as set forth in claim 2, wherein
the at least one control device converts an image capture parameter associated with the at least one first image capturing device into an image capture parameter for the at least one second image capturing device and captures a still image with use of the image capture parameter that has been converted.

4. The electronic device as set forth in claim 2, wherein
the at least one control device carries out, with direct use of an image capture parameter associated with the at least one first image capturing device, the image capturing with use of the at least one second image capturing device.

5. The electronic device as set forth in claim 1, wherein
the image capture parameter includes at least one of an automatic exposure adjustment parameter and a white balance adjustment parameter.

6. The electronic device as set forth in claim 5, wherein
the image capture parameter further includes zooming magnification.

7. A control device for controlling an electronic device, the control device configured to:
carry out, when carrying out image capturing for capturing an image of a subject with use of one of (i) at least one first image capturing device configured to capture a moving image and (ii) at least one second image capturing device configured to capture a still image, a process of the image capturing on the basis of an image capture parameter indicative of an imaging capturing condition in image capturing carried out with use of the other.

8. A control method for controlling an electronic device, the control method comprising:
carrying out, when carrying out image capturing for capturing an image of a subject with use of one of (i) at least one first image capturing device configured to capture a moving image and (ii) at least one second image capturing device configured to capture a still image, a process of the image capturing on the basis of an image capture parameter indicative of an imaging capturing condition in image capturing carried out with use of the other.
